(19) United States
(12) Patent Application Publication
(10) Pub. No.: US 2024/0296409 A1
(43) Pub. Date: Sep. 5, 2024

(54) FUTURE PREDICTION APPARATUS, FUTURE PREDICTION METHOD, AND PROGRAM

(71) Applicant: NIPPON TELEGRAPH AND TELEPHONE CORPORATION, Tokyo (JP)

(72) Inventors: Xiaoxi ZHANG, Tokyo (JP); Machiko SHINOZUKA, Tokyo (JP); Masaki HISADA, Tokyo (JP); Yuriko TANAKA, Tokyo (JP)

(21) Appl. No.: 18/568,524

(22) PCT Filed: Jun. 15, 2021
(86) PCT No.: PCT/JP2021/022737

§ 371 Date: Dec. 8, 2023

(51) Int. Cl. G06Q 10/0637; G06Q 30/0202

(52) U.S. Cl. CPC G06Q 10/06375; G06Q 30/0202

(57) ABSTRACT

A future prediction device predicts future GHG emissions. The future prediction device includes a memory and a processor configured to execute calculating GHG emissions of a predetermined company in a base year; predicting a future social change of an industry to which the predetermined company belongs by using a change scenario of an economic model; and calculating future GHG emissions of the predetermined company from the GHG emissions of the calculated predetermined company based on the future social change of the industry to which the predicted predetermined company belongs.

### TECHNICAL FIELD

The present disclosure relates to a future prediction device, a future prediction method, and a program.

### BACKGROUND ART

As climate change progresses, many countries around the world have set medium-to long-term greenhouse gas (GHG) emission reduction targets. Against this backdrop, there is a growing demand for GHG emission reductions not only at the national level, but also at the industrial and company levels, and more and more companies are actively setting GHG emission reduction targets. For example, Science Based Targets (SBT) is one representative example of company GHG emission reduction targets (NPL 1), and in recent years, an increasing number of companies have set SBTs.

In addition, GHG emission reduction targets of companies have changed from “reducing their own emissions” to simply “reducing emissions throughout the organization's entire supply chain” over the past few years.

The company's GHG emissions are emissions associated with the use of fuel, electric power, etc., and can be expressed as Scope 1 emissions (direct emissions) and Scope 2 emissions (indirect emissions). Scope 1 (direct emissions) counts emissions from the energy conversion sector that directly emits GHG. On the other hand, Scope 2 (indirect emissions) is calculated by assigning GHG emissions to users (companies, households, etc.) who use fuel and electric power generated by direct emissions, according to the consumption of fuel and electric power. The Japanese government uses these statistics.

In addition to Scope 1 and 2 emissions, it is also possible to calculate Scope 3 emissions in order to understand GHG emissions from the supply chain (NPL 2). Scope 1 and 2 emissions are the company's GHG emissions associated with the use of fuel, electric power, etc., while Scope 3 emissions are indirect emissions other than those of Scope 1 and 2 (emissions by other companies related to the activities of specific companies (operators)).

### CITATION LIST

### Non Patent Literature

NPL 1: SBTi, Internet <URL: https://www.wwf.or.jp/activities/basicinfo/409.html>
NPL 2:: “Approach to Calculating Supply Chain Emissions,” Ministry of the Environment, Internet <https://www.env.go.jp/earth/ondanka/supply_chain/gvc/files/tools/suppl y_chain_201711_all.pdf>

### SUMMARY OF INVENTION

### Technical Problem

However, in today's rapidly changing world, even if a company sets a target once and makes a GHG emission reduction plan, for example, social changes such as the promotion of the use of renewable energy and hydrogen energy often have a significant impact on the GHG reduction plan and the degree of target achievement of the company.

The present invention has been made in view of the above points, and an object of the present invention is to quantitatively predict the impact of future social changes on GHG emissions of a company.

### Solution to Problem

In order to solve the above problem, according to the invention of claim 1, there is provided a future prediction device that predicts future GHG emissions, the future prediction device including: base year company emissions calculation means for calculating GHG emissions of a predetermined company in a base year; social change prediction means for predicting a future social change of an industry to which the predetermined company belongs by using a change scenario of an economic model; and future emissions calculation means for calculating future GHG emissions of the predetermined company from the GHG emissions of the predetermined company calculated by the base year company emissions calculation means on the basis of the future social change of the industry to which the predetermined company belongs predicted by the social change prediction means.

### Advantageous Effects of Invention

As described above, according to the present invention, it is possible to quantitatively predict the impact of future social changes on GHG emissions of a company.

### BRIEF DESCRIPTION OF DRAWINGS

FIG. 1 is a schematic diagram of a communication system.

FIG. 2 is an electrical hardware configuration diagram of a future prediction device.

FIG. 3 is an electrical hardware configuration diagram of a communication terminal.

FIG. 4 is a functional configuration diagram of the future prediction device.

FIG. 5 is a flowchart showing processing for automatically predicting the impact of future social changes and technological advances on company GHG emissions.

FIG. 6 is a table showing the energy consumption of company A.

FIG. 7 is a table showing information on purchased products from suppliers.

FIG. 8 is a graph showing GHG emissions up to 2050 in a base scenario.

FIG. 9 is a graph showing GHG emissions up to 2050 in each scenario.

FIG. 10 is a graph showing the rate of change in GHG emissions for each industry in 2050.

FIG. 11 is a table showing the rate of change in GHG emissions for each industry.

### DESCRIPTION OF EMBODIMENTS

Embodiments of the present invention will be described below with reference to the drawings.

### [System Configuration of Embodiment]

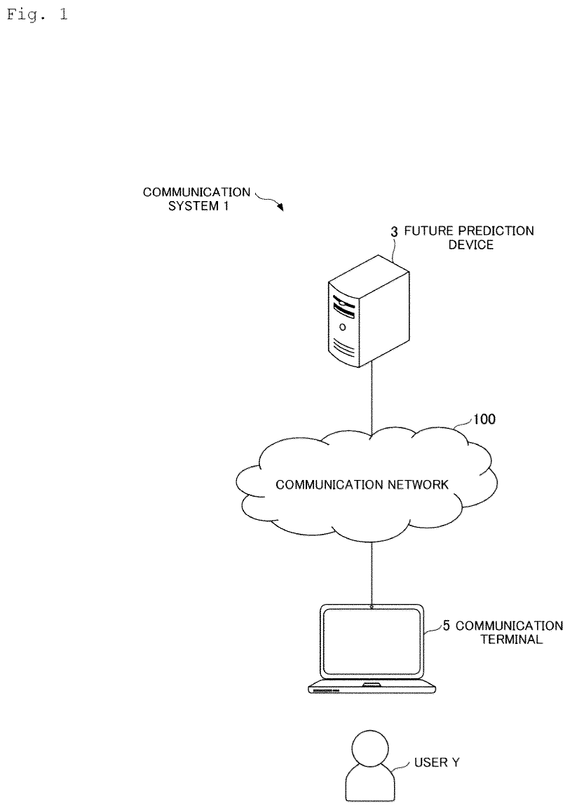

First, the outline of a configuration of a communication system according to the present embodiment will be described with reference to FIG. 1. FIG. 1 is a schematic diagram of a communication system according to an embodiment of the present invention.

As shown in FIG. 1, a communication system 1 of the present embodiment is constructed by a future prediction device 3 and a communication terminal 5. The communication terminal 5 is managed and used by a user Y.

The future prediction device 3 and the communication terminal 5 can communicate with each other via a communication network 100 such as the Internet. The connection form of the communication network 100 may be either wireless or wired.

The future prediction device 3 is composed of one or more computers. When the future prediction device 3 is composed of a plurality of computers, it may be indicated as a “future prediction device” or as a “future prediction system.”

The future prediction device 3 is a device for predicting GHG emissions as future environmental loads. For example, the future prediction device 3 predicts the GHG emissions of a company to be predicted and the entire supply chain of the company according to social changes and technical advances in the future, and outputs result data such as a graph showing prediction results. As an output method, by transmitting the result data to the communication terminal 5, a graph or the like related to the result data may be displayed or printed on the communication terminal 5 side, the graph or the like may be displayed on a display connected to the future prediction device 3, or the graph or the like may be printed on a printer or the like connected to the future prediction device 3.

The communication terminal 5 is a computer, and in FIG. 1, a laptop personal computer is shown as an example. In FIG. 1, the user Y operates the communication terminal 5.

### [Hardware Configuration]

### <Hardware Configuration of Future Prediction Device>

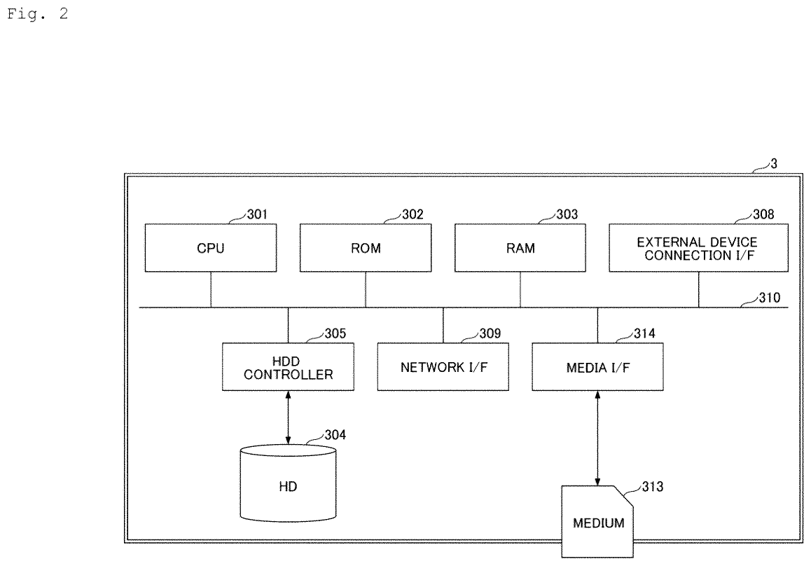

Next, an electrical hardware configuration of the future prediction device 3 will be described with reference to FIG. 2. FIG. 2 is an electrical hardware configuration diagram of the future prediction device.

The future prediction device 3, as a computer, includes, a central processing unit (CPU) 301, a read only memory (ROM) 302, a random access memory (RAM) 303, a hard disk (HD) 304, a hard disk drive (HDD) controller 305, an external device connection interface (I/F) 308, a network I/F 309, a bus line 310, and a media I/F 314, as shown in FIG. 2.

Among them, the CPU 301 controls the overall operation of the future prediction device 3. The ROM 302 stores a program used to drive the CPU 301, such as an initial program load (IPL). The RAM 303 is used as a work area of the CPU 301.

The HD 304 stores various types of data such as a program. The HDD controller 305 controls reading or writing of various types of data to or from the HD 304 according to the control of the CPU 301. In place of the HD 304 and the HDD controller 305, a solid state drive (SSD) and an SSD controller may be mounted.

The external device connection I/F 308 is an interface for connecting various external devices. The external devices in this case are a display, a speaker, a keyboard, a mouse, a Universal Serial Bus (USB) memory, a printer, and the like.

The network I/F 309 is an interface for data communication via the communication network 100. The bus line 310 is an address bus, a data bus, or the like for electrically connecting each component such as the CPU 301 shown in FIG. 2.

Further, the media I/F 314 controls reading or writing (storing) of data to or from a recording medium 313 such as a flash memory. The recording medium 313 includes a digital versatile disc (DVD), a Blu-ray Disc (registered trademark), and the like.

### <Hardware Configuration of Communication Terminal>

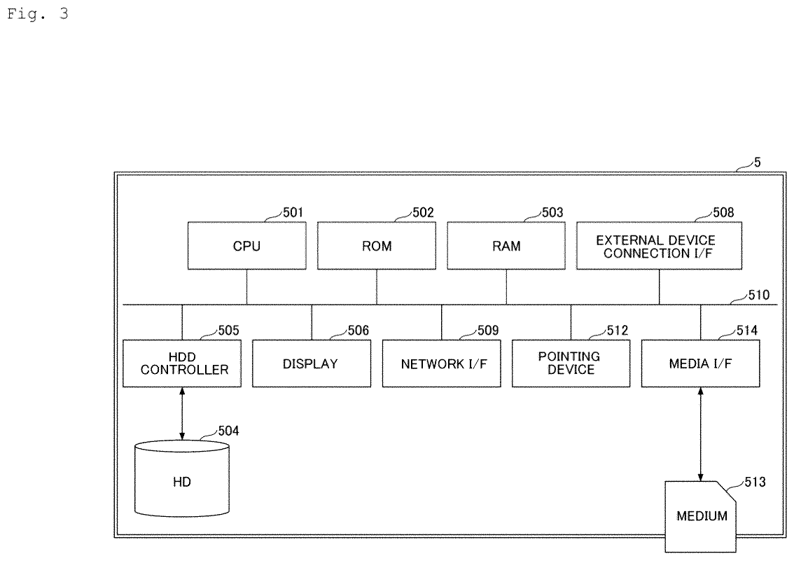

Next, an electrical hardware configuration of the communication terminal 5 will be described with reference to FIG. 3. FIG. 3 is an electrical hardware configuration diagram of the communication terminal.

The communication terminal 5, as a computer, includes, a CPU 501, a ROM 502, a RAM 503, an HD 504, an HDD controller 505, a display 506, an external device connection interface (I/F) 508, a network I/F 509, a bus line 510, a pointing device 512, and a media I/F 514, as shown in FIG. 3.

Among them, the CPU 501 controls the overall operation of the communication terminal 5. The ROM 502 stores a program used to drive the CPU 501, such as an IPL. The RAM 503 is used as a work area of the CPU 501.

The HD 504 stores various types of data such as programs. The HDD controller 505 controls reading or writing of various types of data to the HD 504 according to the control of the CPU 501. In place of the HD 504 and the HDD controller 505, an SSD and an SSD controller may be mounted.

The display 506 is a kind of display means such as a liquid crystal or an organic electro luminescence (EL) for displaying various images. The external device connection I/F 508 is an interface for connecting various external devices. The external devices in this case are a display, a speaker, a keyboard, a mouse, a USB memory, a printer, and the like.

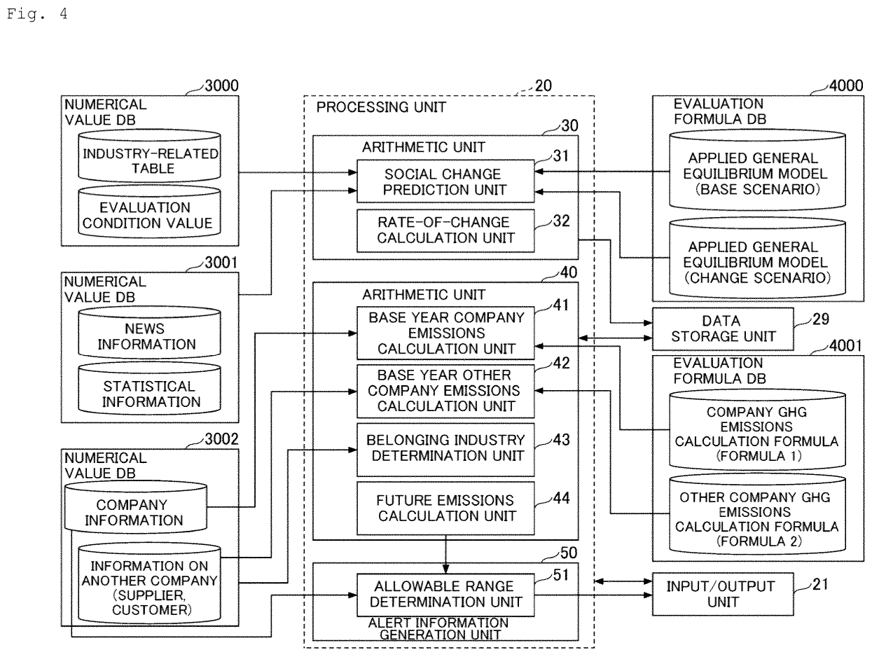

The network I/F 509 is an interface for data communication via the communication network 100. The bus line 510 is an address bus, a data bus, or the like for electrically connecting each component such as the CPU 501 shown in FIG. 4.

The pointing device 512 is a kind of input means for selecting and executing various instructions, selecting an object to be processed, and moving a cursor. When the user Y uses a keyboard, the function of the pointing device 512 may be turned off. The media I/F 514 controls reading or writing (storing) of data to or from a recording medium 513 such as a flash memory. The recording medium 513 includes a DVD, a Blu-ray Disc (registered trademark), and the like.

### [Functional Configuration of Future Prediction Device]

Next, a functional configuration of the future prediction device will be described with reference to FIG. 4. FIG. 4 is a functional configuration diagram of the future prediction device according to the embodiment of the present invention.

In FIG. 4, the future prediction device 3 includes a processing unit 20, an input/output unit 21, and a data storage unit 29. These respective units are functions implemented by an instruction from the CPU 301 of FIG. 2 based on a program. The processing unit 20 includes an arithmetic unit 30, an arithmetic unit 40, and an alert information generation unit 50.

Further, in the RAM 303 or the HD 304 in FIG. 2, a numerical value data base (DB) 3000, a numerical value DB 3001, a numerical value DB 3002, an evaluation formula DB 4000 and an evaluation formula DB 4001 are constructed.

### <DB Configuration>

### (Numerical Value DB)

The numerical value DB 3000 stores and manages an industry-related table for a certain base year and each of pieces of information indicating evaluation condition values such as a prediction year (also referred to as an “evaluation year”). An industry-related table is a table (listed in matrix form) that expresses the amount of inter-industry transactions of goods and services that took place over a certain period of time (usually one year) in a region such as a country or prefecture. To give a simplified example, the matrix expresses that the financial industry received a supply of 100 yen from the information and communication industry and 200 yen from the electric power industry, and produced 500 yen (the added value was 200 yen). The demand and supply of each industry coincide with each other. Japan's Ministry of Internal Affairs and Communications prepares industry-related tables every five years and publishes them as statistical information.

Also, the numerical value DB 3001 stores and manages news information and statistical information for each industry.

Furthermore, the numerical value DB 3002 stores and manages company information on a company and information on another company as a supplier and a customer of the company for each industry. A supplier is a supplier of a product (merchandise) or service to a company for which prediction is to be performed, and a customer is a customer of the company to be predicted.

The above-mentioned news information, statistical information, company information, and information on another company (supplier, customer) are indicators of the state and development of each industry, and are periodically collected and accumulated from various information sources such as mass media and public offices.

### (Evaluation Formula DB)

The evaluation formula DB 4000 stores and manages data of an applied general equilibrium model (base scenario) and data of an applied general equilibrium model (change scenario). The applied general equilibrium model (base scenario) is a model (simultaneous equations) corresponding to the base scenario. The applied general equilibrium model (change scenario) is, for example, a model corresponding to a situation in which a specific industry (for example, the agriculture, forestry and fisheries industry) has developed.

The Applied General Equilibrium Model is disclosed, for example, in the reference (Mitsutaka Matsumoto, “Analysis of Impacts of the Progress of Ubiquitous Technologies on Energy Consumption in Japan,” IEEJ Trans. EIS, Vol. 125, No. 10, 2005), and therefore, detailed description is omitted here.

The evaluation formula DB 4001 stores and manages respective data of company GHG emissions calculation formula (Formula 1) and other company GHG emissions calculation formula (Formula 2).

The company GHG emissions calculation formula (Formula 1) is a formula for calculating GHG emissions in a company to be predicted.

$$\begin{matrix}[ Math . 1 ] & \\ {EM}_{s 12 ( t 0 )} = {\sum }^{i} {Energy}_{( i , t 0 )} * {EF}_{( i , t 0 )} & ( Formula 1 )\end{matrix}$$

EMs12: Total value of GHG emissions of Scope 1 (direct emissions) and Scope 2 (indirect emissions) of the company to be predicted
Energy: Energy consumption
EF: GHG emission factor of energy type
i: Type of energy
t0: Base year of prediction

Scope 1 (direct emissions) counts emissions from the energy conversion sector that directly emits GHG. Scope 2 (indirect emissions) is calculated by assigning GHG emissions to users (companies, households, etc.) who use fuel and electric power generated by direct emissions, according to the consumption of fuel and electric power. The Japanese government uses these statistics.

In addition, the other company GHG emissions calculation formula (Formula 2) is a formula for calculating the GHG emissions of the entire supply chain related to the company to be predicted in (Formula 1).

$$\begin{matrix}[ Math . 2 ] & \\ {EM}_{s 3 ( t 0 )} = {\sum }_{c} {EC}_{( c , t 0 )} & ( Formula 2 )\end{matrix}$$

EMs3: Total value of GHG emissions of Scope3 of the company to be predicted
s3: Scope3
c: Category of Scope3

Scope 1 and 2 emissions are the company's GHG emissions associated with the use of fuel, electric power, etc., while Scope 3 emissions are indirect emissions other than those of Scope 1 and 2 (emissions by other companies related to the activities of specific companies (operators)).

In addition, for Category 1 (purchased products and services) of Scope 3, (Formula 3) is used to calculate GHG emissions resulting from products purchased by the company to be predicted from major suppliers.

$$\begin{matrix}[ Math . 3 ] & \\ {EC}_{( c 1 , t 0 )} = {\sum }^{r} {Sup}_{( r , t 0 )} * {Emp}_{( r , t 0 )} & ( Formula 3 )\end{matrix}$$

Sup: Product purchase amount from a predetermined supplier
Emp: GHG emission intensity of purchased products
r: Supplier

### <Each Functional Configuration>

Next, each functional configuration of the future prediction device will be described with reference to FIGS. 2 to 4.

The input/output unit 21 inputs each piece of information on the base year and the prediction period of prediction to the processing unit 20 via the external device connection I/F 308, the network I/F 309, or the media I/F 314 shown in FIG. 2. When via the network I/F 309, each piece of information on the base year and the prediction period of prediction is sent from the communication terminal 5 via the communication network 100.

Further, the input/output unit 21 outputs result data obtained by calculating the GHG emissions by the processing unit 20, and shows alert information to the user Y or the like when the alert information is generated. The result data are the GHG emissions of a company to be predicted in a specific prediction year, and the respective GHG emissions of other companies such as suppliers and customers of the company to be predicted in a specific prediction year. Examples of output include an output by a display, a printer, or the like connected to the external device connection I/F 308, or an output obtained by transmitting result data from the network I/F 309 to the communication terminal 5 via the communication network 100.

The data storage unit 29 is implemented by the RAM 303, the HD 304, or the medium 313 in FIG. 2 and stores various types of data (information).

Further, the arithmetic unit 30 of the processing unit 20 includes a social change prediction unit 31 and a rate-of-change calculation unit 32.

Among them, the social change prediction unit 31 predicts each future social change of the industry to which a predetermined company belongs and the industry to which other companies related to the activities of the company belong, using the change scenario of an economic model. Social changes include economic changes, climate changes, and changes in relations between nations.

For example, in an initial state, the social change prediction unit 31 acquires an industry-related table and evaluation condition values from the numerical value DB 3000, acquires data of an economic model (for example, an applied general equilibrium model (base scenario)) from the evaluation formula DB 4000, and calculates base data showing the state of society and the economy (production value, GHG emissions, etc. of each industry) during the prediction period, thereby generating a base scenario. In this case, the social change prediction unit 31 converts the industry-related table and evaluation condition values into a form that can be expressed in the applied general equilibrium model, and inputs the converted information to the applied general equilibrium model. In addition, the social change prediction unit 31 acquires news information and statistical information from the numerical value DB 3001 and acquires data of an economic model (for example, an applied general equilibrium model (change scenario)) from the evaluation formula DB 4000 in order to catch predictions of social changes, and calculates change data showing the changing state of society and the economy (production value, GHG emissions, etc. of each industry) during the prediction period, thereby predicting and generating a change scenario. In this case, the social change prediction unit 31 converts the news information and statistical information into a form that can be expressed in the applied general equilibrium model, and inputs the converted information to the applied general equilibrium model.

The rate-of-change calculation unit 32 calculates a rate of change in GHG emissions of each year in each industry on the basis of the change data calculated by the social change prediction unit 31 for each year during the prediction period. In addition, the rate-of-change calculation unit 32 stores data on the calculated rate of change in GHG emissions in the data storage unit 29.

Next, the arithmetic unit 40 of the processing unit 20 will be described. The arithmetic unit 40 includes a base year company emissions calculation unit 41, a base year other company emissions calculation unit 42, a belonging industry determination unit 43, and a future emissions calculation unit 44.

Among them, the base year company emissions calculation unit 41 calculates GHG emissions of a predetermined company in a base year.

More specifically, the base year company emissions calculation unit 41 acquires company information from the numerical value DB 3002, acquires the company GHG emissions calculation formula (Formula 1) from the evaluation formula DB 4001, and calculates the GHG emissions (Scope 1, 2) of the company to be predicted. Also, when the company information does not include a GHG emission reduction target value of the company to be predicted, the base year company emissions calculation unit 41 sets the GHG emission reduction target value for the prediction period and stores the set value in the data storage unit 29. Similarly, when the company information does not include an allowable deviation range (threshold value) for the GHG emission reduction target value, the base year company emissions calculation unit 41 sets an allowable deviation range (threshold value) during the prediction period and stores the set value in the data storage unit 29.

The base year other company emissions calculation unit 42 calculates GHG emissions of other companies related to the activities of a predetermined company in the base year. GHG emissions of other companies related to the activities of a predetermined company includes GHG emissions resulting from transactions or contracts with other companies such as suppliers and customers of the company. GHG emissions resulting from the transaction or contract include GHG emissions resulting from products purchased by the company from its suppliers.

More specifically, the base year other company emissions calculation unit 42 acquires information on another company (supplier, customer) related to the company to be predicted from the numerical value DB 3002, acquires the other company GHG emissions calculation formula (Formula 2) from the evaluation formula DB 4001, and thereby calculates the GHG emissions (Scope 3) of the supply chain (excluding the company to be predicted) related to the company to be predicted. Also, when the information on another company (supplier, customer) does not include each GHG emission reduction target value of the supplier or customer of the company to be predicted, the base year other company emissions calculation unit 42 sets each GHG emission reduction target value of the supplier or customer for the prediction period and stores the set value in the data storage unit 29. Similarly, when the information on another company (supplier, customer) does not include an allowable deviation range (threshold value) for each GHG emission reduction target value of the supplier or customer, the base year other company emissions calculation unit 41 sets the allowable deviation range (threshold value) during the prediction period and stores the set value in the data storage unit 29.

The belonging industry determination unit 43 acquires company information of a company to be predicted and information on another company (supplier, customer) related to the company to be predicted from the numerical value DB 3001, and determines the industry to which each company belongs.

The future emissions calculation unit 44 calculates future GHG emissions of a predetermined company from the GHG emissions of the company calculated by the base year company emissions calculation unit 41 on the basis of the future social change of the industry to which the predetermined company belongs predicted by the social change prediction unit 31. In addition, the future emissions calculation unit 44 calculates future GHG emissions of other companies from the GHG emissions of other companies calculated by the base year other company emissions calculation unit 42 on the basis of the future social change of the industry to which other companies (suppliers and customers) belong predicted by the social change prediction unit 31.

More specifically, the future emissions calculation unit 44 multiplies the GHG emissions (Scope 1, 2) of the company to be predicted in the base year of prediction calculated by the base year company emissions calculation unit 41 by the rate of change in GHG emissions of the industry of the company to be predicted in each prediction year calculated by the rate-of-change calculation unit 32, and thereby calculates the GHG emissions that have changed in each prediction year of the company to be predicted. In addition, the future emissions calculation unit 44 multiplies each GHG emissions (Scope 3) of other companies (suppliers and customers) related to the company to be predicted in the base year of prediction calculated by the base year other company emissions calculation unit 42 by the rate of change in GHG emissions for each industry of a supplier and a customer in each prediction year calculated by the rate-of-change calculation unit 32, and thereby calculates the GHG emissions that have changed in each prediction year of other companies (supplier and customer). Thus, the future emissions calculation unit 44 can calculate the GHG emissions (Scope 1, 2, 3) of the entire supply chain including the company to be predicted in each prediction year.

Next, the alert information generation unit 50 of the processing unit 20 will be described. The alert information generation unit 50 includes an allowable range determination unit 51. The allowable range determination unit 51 acquires company information (in this case, GHG emission reduction target information of a company to be predicted, each of pieces of GHG emission reduction target information on other companies (suppliers and customers) related to activities of the company, and each of pieces of allowable deviation range information) from the numerical value DB 3002, and determines whether or not each of the GHG emissions (Scope 1, 2) and the GHG emissions (Scope 3) calculated by the future emissions calculation unit 44 exceed an allowable deviation threshold value with respect to a reduction target value indicated by each of pieces of GHG emission reduction target information. When the result exceeds the threshold value, the alert information generation unit 50 automatically generates alert information.

### [Processing or Operation]

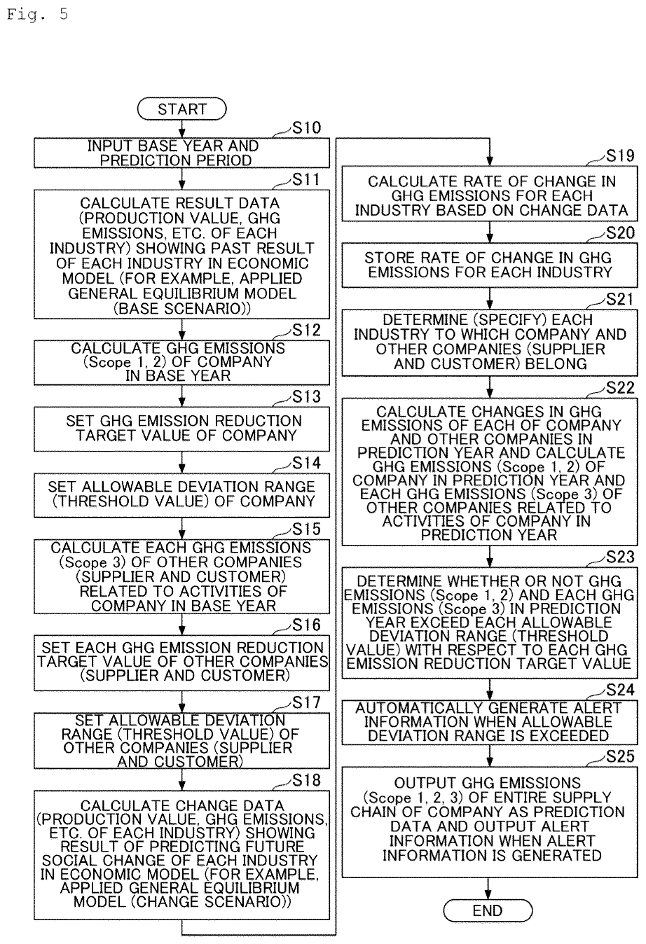

Next, the processing or operation of the present embodiment will be described in detail with reference to FIGS. 5 to 10.

FIG. 5 is a flowchart showing a process of automatically predicting an impact on GHG emissions of the company due to social changes in the future (technological changes, climate changes, changes in relations between nations, and the like). In the present embodiment, in the future, when the utilization of hydrogen energy (hydrogen society) develops and 10% of hydrogen power generation is introduced by 2050, an example of predicting the impact on GHG emissions of the entire supply chain including company A (telecommunications company) is shown.

First, as shown in FIG. 5, the input/output unit 21 inputs each piece of information about the base year of prediction and the prediction period as information about the prediction object (S11). For example, the user Y sets the base year of prediction as 2015 and the prediction period as 2015 to 2050.

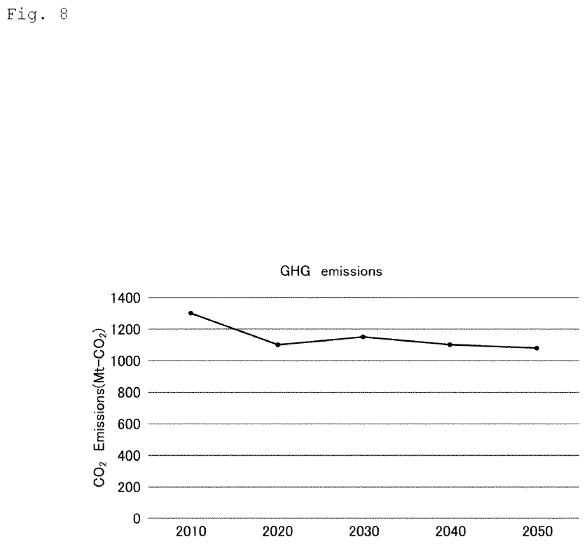

Next, the social change prediction unit 31 acquires an industry-related table and evaluation condition values from the numerical value DB 3000 and acquires data of an economic model (for example, an applied general equilibrium model (base scenario)) from the evaluation formula DB 4000, and calculates base data showing an economical result of each industry (production value, GHG emissions, etc. of each industry) in the base scenario (S1l). FIG. 8 is a graph showing GHG emissions up to 2050 in the base scenario. As shown in FIG. 8, the social change prediction unit 31 calculates the GHG emissions as base data.

Next, the base year company emissions calculation unit 41 acquires company information from the numerical value DB 3002, acquires a company GHG emissions calculation formula (Formula 1) from the evaluation formula DB 4001, and calculates GHG emissions (Scope 1, 2) of a company to be predicted (S12).

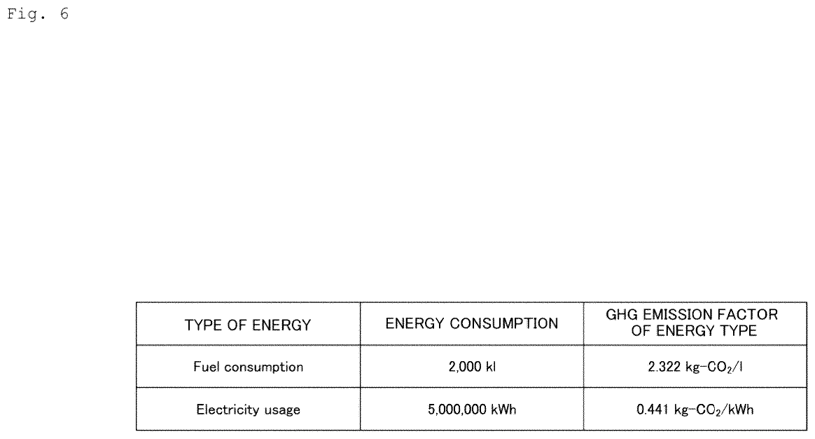

For example, the base year company emissions calculation unit 41 uses (Formula 1) and company information (for example, a value of FIG. 6) to calculate the GHG emissions (Scope 1, 2) of the company (company A) in 2015 as shown below. In addition, FIG. 6 is a table showing the energy consumption of company A. The numerical values in the table are fictitious.

$$\begin{matrix}[ Math . 4 ] & \\ {EM}_{s 12 ( 2015 )} = 6849000 & ( kg )\end{matrix}$$

When the company information does not include a GHG emission reduction target value of the company to be predicted, the base year company emissions calculation unit 41 sets the GHG emission reduction target value of the company to be predicted during the prediction period, and stores the set value in the data storage unit 29 (513). For example, the base year company emissions calculation unit 41 sets the GHG emission reduction target value to 3,598,000 kg by 2030 on the basis of the emission reduction target value of 4.2% every year.

Similarly, when the company information does not include an allowable deviation range (threshold value) for the GHG emission reduction target value of the company to be predicted, the base year company emissions calculation unit 41 sets the allowable deviation range (threshold value) of the company to be predicted during the prediction period, and stores the set value in the data storage unit 29 (S14). For example, the base year company emissions calculation unit 41 sets “±5%” as the allowable deviation range.

Next, the base year other company emissions calculation unit 42 acquires information on another company (supplier, customer) related to the company to be predicted from the numerical value DB 3002, acquires the other company GHG emissions calculation formula (Formula 2) from the evaluation formula DB 4001, and thereby calculates each GHG emissions (Scope 3) of the supplier and customer related to the company to be predicted (S15).

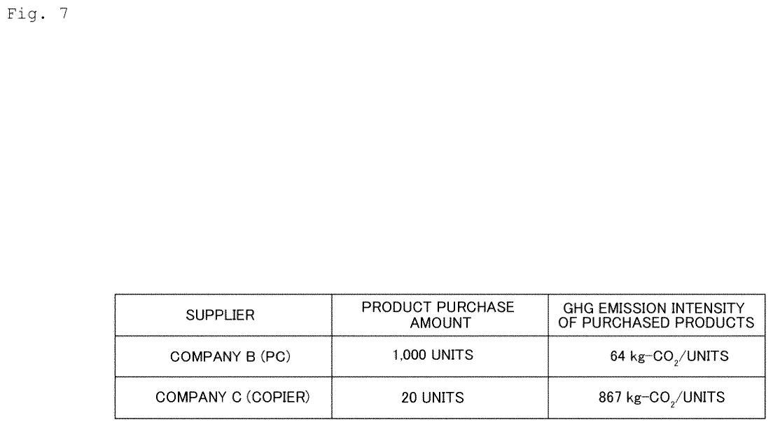

At this time, the base year other company emissions calculation unit 42 uses (Formula 3) in advance to calculate, for example, the GHG emissions resulting from products purchased from major suppliers in Category 1 (purchased products and services) of GHG emissions (Scope 3). Here, the base year other company emissions calculation unit 42 calculates the GHG emissions resulting from products purchased from two major suppliers (company B and company C) in Category 1 (purchased products and services) of Scope 3 using the values shown in FIG. 7 as follows. FIG. 7 is a table showing information on purchased products from suppliers. The numerical values in the table are fictitious.

$$\begin{matrix}[ Math . 5 ] & \\ {EC}_{( c 1 , 2015 )} = 81340 & ( kg )\end{matrix}$$

When the company information does not include each GHG emission reduction target value of other companies (supplier and customer) related to the company to be predicted, the base year other company emissions calculation unit 42 sets the GHG emission reduction target value of other companies (supplier and customer) during the prediction period, and stores the set value in the data storage unit 29 (S16). Even when the company information does not include the GHG emission reduction target value of at least one of the supplier and the customer, the base year other company emissions calculation unit 42 sets the GHG emission reduction target value, and stores the set value in the data storage unit 29. In addition, when there are a plurality of suppliers and a plurality of customers, the base year other company emissions calculation unit 42 sets a predetermined GHG emission reduction target value not included in the company information among them, and stores the set value in the data storage unit 29.

Next, when the company information does not include an allowable deviation range (threshold value) for each GHG emission reduction target value of the supplier and customer of the company to be predicted, the base year other company emissions calculation unit 42 sets each allowable deviation range (threshold value) of the supplier and customer during the prediction period, and stores the set value in the data storage unit 29 (S17). Even when the company information does not include the allowable deviation range (threshold value) of at least one of the supplier and the customer, the base year other company emissions calculation unit 42 sets the allowable deviation range (threshold value), and stores the set value in the data storage unit 29. In addition, when there are a plurality of suppliers and a plurality of customers, the base year other company emissions calculation unit 42 sets a predetermined allowable deviation range (threshold value) not included in the company information among them, and stores the set value in the data storage unit 29.

Next, the social change prediction unit 31 acquires news information and statistical information from the numerical value DB 3001 and acquires data of an economic model (for example, an applied general equilibrium model (change scenario)) from the evaluation formula DB 4000 to catch predictions of social changes, and calculates change data showing economic prediction of each industry (production value, GHG emissions, etc. of each industry) in the future society in the change scenario (S18).

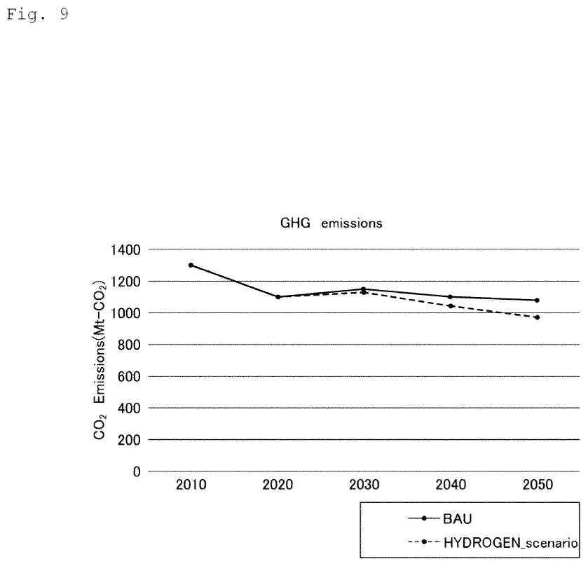

For example, the social change prediction unit 31 catches information that 10% of hydrogen power generation will be introduced by 2050 from news information, and uses an economic model to predict social changes (GHG emissions for each industry, etc.) for each year during the prediction period due to the changes. The change data calculated by this prediction is shown as a hydrogen scenario in FIG. 9. FIG. 9 is a graph showing GHG emissions up to 2050 in each scenario. FIG. 9 shows GHG emissions due to the development of a hydrogen society when the base data shown in FIG. 8 is Business as usual (BAU).

Next, the rate-of-change calculation unit 32 calculates a rate of change in GHG emissions for each industry indicated by the change data calculated by the social change prediction unit 31 by using the following Formula (4) (S19).

For example, in the case of the above-mentioned hydrogen scenario, the rate-of-change calculation unit 32 calculates the rate of change in GHG emissions for each industry for each year during the prediction period in the hydrogen scenario, as shown below.

$$\begin{matrix}[ Math . 6 ] & \\ {R}_{( s , t )} = {EMS}_{( s , t )} / {EMS}_{( s , t 0 )} & ( Formula 4 )\end{matrix}$$

R: Rate of change in GHG emissions
EMS: GHG emissions for each industry
s: Industry
t: Any prediction year

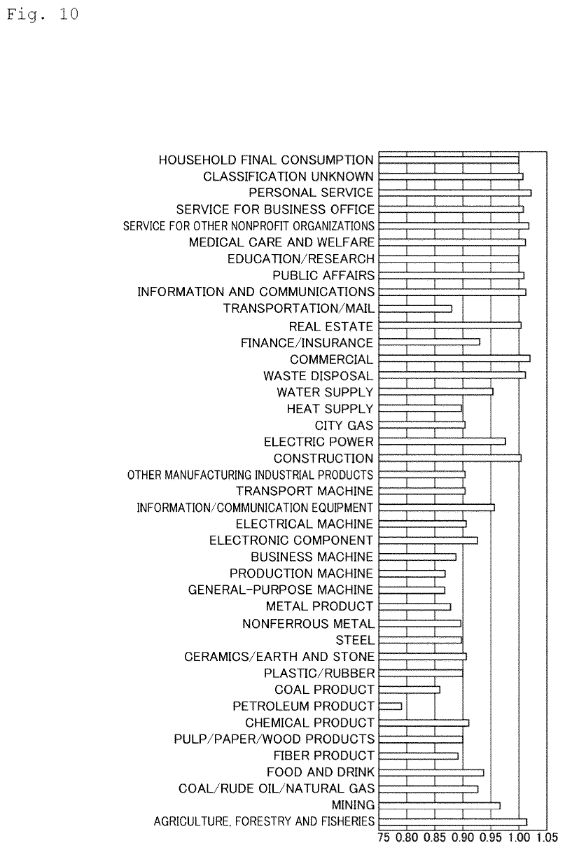

FIG. 10 is a graph showing the rate of change in the GHG emissions for each industry in 2050. FIG. 10 shows, by way of example, the rate of change in GHG emissions for each industry in 2050 (value=1 in the base scenario of 2050).

Next, the rate-of-change calculation unit 32 stores data on the calculated rate of change in GHG emissions in the data storage unit 29 (S20).

Next, the belonging industry determination unit 43 acquires company information of a company to be predicted and information on another company (supplier, customer) related to the company to be predicted from the numerical value DB 3001, and determines the industry to which each company belongs (S21).

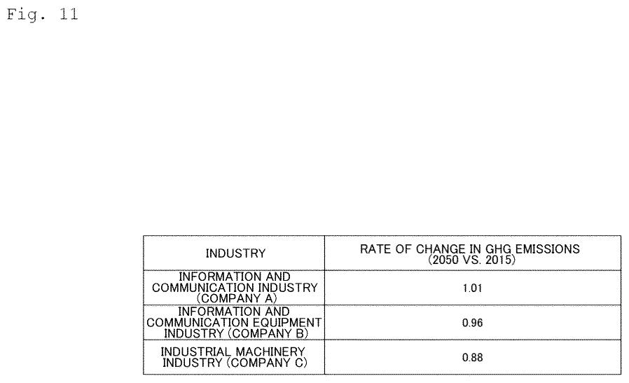

For example, each industry to which company A and companies B and C, which are suppliers of company A, belong to is determined (specified). FIG. 11 is a table showing the rate of change in GHG emissions for each industry. FIG. 11 shows a case where it is determined that company A belongs to the information and communication industry, company B which is a supplier belongs to the information and communication equipment industry, and company C which is a supplier belongs to the industrial machinery industry. The rate of change in GHG emissions for each industry of company A, company B, and company C is calculated in step S19.

Next, the future emissions calculation unit 44 uses the GHG emissions (Scope 1, 2) of the company to be predicted in the base year of prediction calculated by the base year company emissions calculation unit 41, each GHG emissions (Scope 3) of other companies (suppliers and customers) related to the company to be predicted in the base year of prediction calculated by the base year other company emissions calculation unit 42, and the rate of change in GHG emissions for each of the industry of the company to be predicted and the industries of other companies (suppliers and customers) related to the company to be predicted in the base year of prediction calculated by the rate-of-change calculation unit 32, and calculates the GHG emissions of each of the company to be predicted in the base year of prediction and other companies (supplier and customer) of the company (S22). Thus, the future emissions calculation unit 44 can calculate the GHG emissions (Scope 1, 2, 3) of the entire supply chain including the company to be predicted in the base year of prediction.

For example, the future emissions calculation unit 44 multiplies the GHG emissions of company A and companies B and C which are suppliers of company A in the base year (2015) by the rate of change in GHG emissions in the industry to which they belong, and thereby calculates the GHG emissions of company A and companies B and C which are suppliers of company A in the prediction year. When there is detailed information about the GHG emissions of the company to be predicted, the future emissions calculation unit 44 can also calculate the GHG emissions by a method different from the above processing.

The case of the hydrogen scenario will now be described in more detail.

For the GHG emissions (Scope 1, 2) in the prediction year 2050 of company A in the hydrogen scenario, the future emissions calculation unit 44 calculates the values shown below.

$$\begin{matrix}[ Math . 7 ] & \\ {EM}_{( s 12 \_ h , 2050 )} = 3,598,000 * 1.01 = 3,633,980 & ( kg )\end{matrix}$$

In addition, regarding the amount of change in GHG emissions of companies B and C which are suppliers of company A in the prediction year 2050 in the hydrogen scenario, the future emissions calculation unit 44 regards the rate of fluctuation of the industry to which each of companies B and C which are suppliers belongs as the rate of change of the GHG emission intensity of purchased products, and calculates the GHG emissions of Category 1 (purchased products and services) of Scope 3 in the prediction year 2050 using (Formula 5) as shown below.

$$\begin{matrix}[ Math . 8 ] & \\ {EC}_{( c 1 , t )} = {\sum }^{r} {Sup}_{( r , t )} * ( {Emp}_{( r , t 0 )} * {R}_{( s , t )} & ( Formula 5 )\end{matrix}$$

$$\begin{matrix}[ Math . 9 ] & \\ {EC}_{( c 1 \_ h 2 , 2050 )} = 47842 & ( kg )\end{matrix}$$

Next, the allowable range determination unit 51 acquires company information (GHG emission reduction target information and allowable deviation range information of the company to be predicted) from the numerical value DB 3002, and determines whether or not the GHG emissions of the company to be predicted in the base year of prediction calculated by the future emissions calculation unit 44 exceed the allowable deviation threshold value with respect to the GHG emission reduction target indicated by the GHG emission reduction target information of the company to be predicted (S23). Then, when the allowable deviation threshold value is exceeded, the alert information generation unit 50 automatically generates alert information (S24).

For example, when a GHG emissions deviation K for the prediction year (2050) calculated in step S22 above exceeds an allowable deviation threshold value (for example, ±5%) with reference to the GHG emission reduction target set by company A, alert information is generated. In this case, as shown below, company A's own GHG emissions in Scope 1, 2 deviate by only 1% (=1.01-1.00) due to the introduction of 10% hydrogen. However, since the GHG emissions of companies B and C which are suppliers in Scope 3 of company A deviate by −7% (=0.93-1.00) due to the introduction of 10% hydrogen, the alert information generation unit 50 generates alert information.

$$\begin{matrix}[ Math . 10 ] & \\ K\_scope1 , 2 = {EM}_{( s 12 , 2050 )} / {EM}_{( s 12 \_ h , 2050 )} = 1.01 & \end{matrix}$$

$$\begin{matrix}[ Math . 11 ] & \\ K\_scope3 = {EC}_{( c 1 \_ h , 2050 )} / {EC}_{( c 1\_ h , 2050 )} = 0.93 & \end{matrix}$$

Finally, the input/output unit 21 outputs the GHG emissions result of the entire supply chain including the company to be predicted, calculated in step S21 above, and when alert information is generated, the input/output unit presents the alert information to a user Y or the like (S25).

### Effect of Embodiment

As described above, according to the present embodiment, it is possible to quantitatively predict the impact of the future social change on the GHG emissions of a predetermined company.

Further, by quantitatively predicting the impact on the GHG emissions of not only a predetermined company but also another company (supplier, customer) related to the activities of the company, it is possible to quantitatively predict the impact on GHG emissions of the entire supply chain including the predetermined company. Thus, since the future GHG emissions of a predetermined company can be predicted more accurately, the problem that the GHG emission reduction plan must be largely reviewed can be solved. Further, the manager and the department in charge of the company can use the prediction result for planning a proactive management strategy.

Further, when the prediction result deviates from the GHG emission reduction target of the company, the fact can be notified to the user Y himself or herself or the manager or the department in charge via the user Y, which can be used for planning a more flexible management strategy.

### [Supplementary Notes]

The present invention is not limited to the above-described embodiment, and may be configured or processed (operations) as described below.
(1) The future prediction device 3 of the present invention can also be realized by a computer and a program, and the program can be recorded in a recording medium or provided through a communication network.
(2) The allowable range determination unit 51 determines whether or not the GHG emissions of the company to be predicted in the base year of prediction “exceed” the allowable deviation threshold value with respect to the set target indicated by the GHG emission reduction target information of the company to be predicted, but the present invention is not limited thereto. For example, the allowable range determination unit 51 may determine whether or not the GHG emissions are “equal to or greater than” the allowable deviation threshold value with respect to the set target. In addition, the allowable range determination unit 51 may determine only that the GHG emissions exceeds the allowable deviation threshold value or only that the GHG emissions do not exceed the allowable deviation threshold value, or only that the GHG emissions are equal to or greater than the allowable deviation threshold value or only that the GHG emissions are not equal to or greater than the allowable deviation threshold value (less than the allowable deviation threshold value), instead of determining whether or not the GHG emissions exceed or are equal to or greater than the allowable deviation threshold value.
(3) In communication between the future prediction device 3 and the communication terminal 5, another device (server, router, etc.) may relay data. For example, in the present specification, for simplification, it is described that the input/output unit 21 of the future prediction device 3 transmits change data to the communication terminal 5, but this transmission process also includes the case where the change data is relayed by another device.
(4) In the above embodiment, a laptop personal computer is shown as an example of the communication terminal 5, but the present invention is not limited thereto, and for example, a desktop personal computer, a tablet terminal, a smartphone, a smartwatch, a car navigation device, a refrigerator, a microwave oven, or the like may be used.
(5) Each of the CPUs 301 and 501 may be not only a single one but may be a plurality of CPUs.
(6) A neural network may be used in the processing of at least one of the above-mentioned units 31, 32, 41, 42, 43, 44, and 51.

### REFERENCE SIGNS LIST

1 Communication system
3 Future prediction device
5 Communication terminal
21 Input/output unit (one example of output means)
29 Data storage unit
30 Arithmetic unit
31 Social change prediction unit (one example of social change prediction means)
32 Rate-of-change calculation unit (one example of change rate calculation means)
40 Arithmetic unit
41 Base year company emissions calculation unit (one example of base year company emissions calculation means)
42 Base year other company emissions calculation unit (one example of base year other company emissions calculation means)
43 Belonging industry determination unit
44 Future emissions calculation unit (one example of future emissions calculation means)
50 Alert information generation unit (one example of alert information generation means)
51 Allowable range determination unit
3000 Numerical value DB
3001 Numerical value DB
3002 Numerical value DB
4000 Evaluation formula DB
4001 Evaluation formula DB

1. A future prediction device that predicts future GHG emissions, the future prediction device comprising:
a memory; and
a processor configured to execute:
calculating GHG emissions of a predetermined company in a base year;
predicting a future social change of an industry to which the predetermined company belongs by using a change scenario of an economic model; and
calculating future GHG emissions of the predetermined company from the GHG emissions of the calculated predetermined company based on the future social change of the industry to which the predicted predetermined company belongs.

2. The future prediction device according to claim 1, the processor is further configured to execute:
calculating GHG emissions of another company related to activities of the predetermined company in the base year,
wherein the processor predicts a future social effect of an industry to which the other company belongs by using the change scenario of the economic model, and
the processor calculates future GHG emissions of the other company from the GHG emissions of the other calculated company based on the future social change of the industry to which the other predicted company belongs.

3. The future prediction device according to claim 1, the processor is further configured to execute:
outputting alert information when the future GHG emissions of the calculated predetermined company exceed or are equal to or greater than an allowable deviation range with respect to a GHG emission reduction target value.

4. The future prediction device according to claim 2, al processor is further configured to execute:
outputting alert information when the future GHG emissions of the other calculated company exceed or are equal to or greater than an allowable deviation range with respect to a GHG emission reduction target value.

5. The future prediction device according to claim 1, wherein the economic model is an applied general equilibrium model.

6. The future prediction device according to claim 1, wherein a neural network in a memory is used by the processor.

7. A future prediction method performed by a future prediction device that includes a memory and a processor to edict future GHG emissions, the future prediction method comprising:
calculating GHG emissions of a predetermined company in a base year;
predicting a future social change of an industry to which the predetermined company belongs by using a change scenario of an economic model; and
calculating future GHG emissions of the predetermined company from the GHG emissions of the calculated predetermined company based on the future social change of the industry to which the predicted predetermined company belongs.

8. (canceled)

9. A non-transitory computer-readable recording medium having computer-readable instructions stored thereon, which, when executed, cause a computer to execute a method, the method comprising:
calculating GHG emissions of a predetermined company in a base year;
predicting a future social change of an industry to which the predetermined company belongs by using a change scenario of an economic model; and
calculating future GHG emissions of the predetermined company from the GHG emissions of the calculated predetermined company based on the future social change of the industry to which the predicted predetermined company belongs.
